(19) United States
(12) Patent Application Publication
(10) Pub. No.: US 2014/0004005 A1
(43) Pub. Date: Jan. 2, 2014

(54) SYSTEM FOR SENSING SOF OF DIESEL ENGINE

(71) Applicant: HYUNDAI MOTOR COMPANY, Seoul (KR)

(72) Inventor: Cheol Beom LIM, Hwaseong-si (KR)

(73) Assignee: Hyundai Motor Company, Seoul (KR)

(21) Appl. No.: 13/683,666

(22) Filed: Nov. 21, 2012

(30) Foreign Application Priority Data
Jun. 29, 2012 (KR) 10-2012-0071126

(51) Int. Cl. G01N 25/28

(52) U.S. Cl. CPC G01N 25/28
USPC 422/94

(57) ABSTRACT

A system for sensing SOF (soluble organic fraction) of a diesel engine, may include a combustion element including a porous ceramic structure supported with a catalyst material which causes a combustion reaction of the SOF in exhaust gas of the diesel engine, a comparative element including a porous ceramic structure supported with a stable material which does not cause a combustion reaction of the SOF, and a detecting unit detecting a temperature of the combustion element and a temperature of the comparative element and determining an amount of the SOF in the exhaust gas using a temperature difference between the combustion element and the comparative element.

### CROSS-REFERENCE TO RELATED APPLICATION

The present application claims priority to Korean Patent Application No. 10-2012-0071126, filed on Jun. 29, 2012, the entire contents of which is incorporated herein for all purposes by this reference.

### BACKGROUND OF THE INVENTION

1. Field of the Invention

The present invention relates to a system for sensing SOF of a diesel engine, which can determine the amount of SOF (soluble organic fraction) discharged from a diesel engine.

2. Description of Related Art

Generally, since a diesel oxidation catalyst (DOC) system is basically similar to oxidation catalyst technology which was being used in gasoline engines before ternary catalysts were developed, its technical effect and performance have already been assured. An oxidation catalyst, such as platinum (Pt), palladium (Pd) or the like, functions to remove hydrocarbons, carbon monoxide and the like from exhaust gas using oxygen in the air. Particularly, when hydrocarbons constituting the particulate matter are reduced, the particulate matter can be reduced by 10˜20%.

That is, a DOC system is the technology that is the most effective at removing the SOF (soluble organic fraction) from PM (particulate matter). SOF is a basic hydrocarbon component, and its discharge amount greatly depends on the operating conditions of an engine. Therefore, in order to efficiently operate an engine and DOC system, it is required to a technology which can detect the discharge amount of SOF in real time. However, SOF sensing technologies which can be mounted in vehicles have not yet been developed, and it was also impossible to selectively determine the discharge amount of SOF using conventional PM sensing technologies.

Therefore, the development of a novel-concept contact-combustion type SOF sensor is being required. In order to realize the contact-combustion type SOF sensor, it is necessary to develop a catalyst having high selectivity and combustion activity for SOF.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a system for sensing the SOF of a diesel engine, which can selectively sense the amount of SOF in PM of exhaust gas discharged from a diesel engine in real time.

In an aspect of the present invention, a system for sensing SOF (soluble organic fraction) of a diesel engine, may include a combustion element including a porous ceramic structure supported with a catalyst material which causes a combustion reaction of the SOF in exhaust gas of the diesel engine, a comparative element including a porous ceramic structure supported with a stable material which does not cause a combustion reaction of the SOF, and a detecting unit detecting a temperature of the combustion element and a temperature of the comparative element and determining an amount of the SOF in the exhaust gas using a temperature difference between the combustion element and the comparative element.

The ceramic structure of the combustion element or the comparative element is made of a composition including Al₂O₃.

The ceramic structure of the comparative element or the comparative element is made of a composition including SiO₂.

The stable material may include TiO₂ as a main component.

The catalytic material uses TiO₂ as a support, and is supported with an element causing the combustion reaction of the SOF.

The element is platinum (Pt).

The system for sensing the SOF of the diesel engine may further include a heating unit for heating the combustion element such that the catalytic material can cause the combustion reaction of the SOF in the exhaust gas.

The heating unit heats the combustion element and the comparative element in the same manner.

The detecting unit converts the temperature difference between the combustion element and the comparative element into an electric signal to determine the amount of the SOF in the exhaust gas.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing a system for sensing the SOF of a diesel engine according to an exemplary embodiment of the present invention.

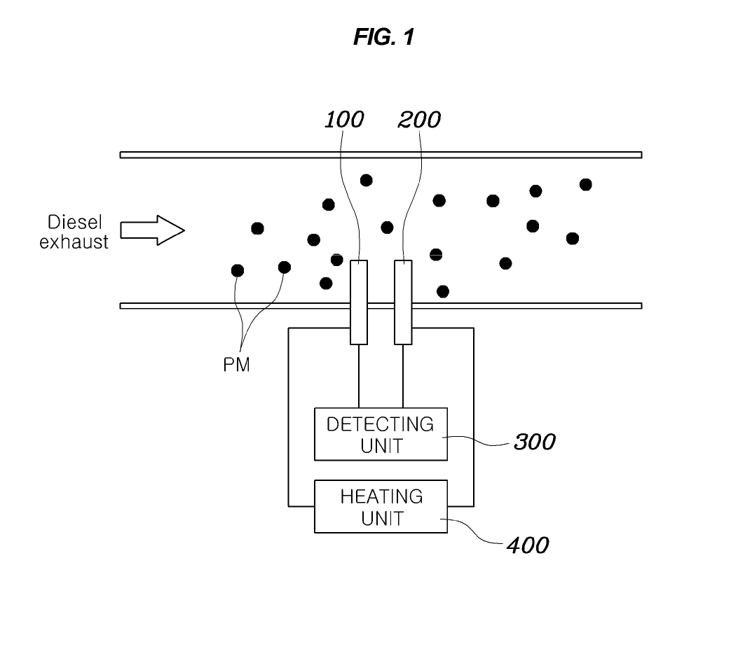

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the attached drawings.

FIGURE is a schematic view showing a system for sensing the SOF of a diesel engine according to an exemplary embodiment of the present invention. The system for sensing the SOF of a diesel engine according to an exemplary embodiment of the present invention includes, a combustion element 100 including a porous ceramic structure supported with a catalyst material which causes a combustion reaction of SOF in the exhaust gas of a diesel engine, a comparative element 200 including a porous ceramic structure supported with a stable material which does not cause a combustion reaction of SOF, and a detecting unit 300 detecting the temperature of the combustion element 100 and the temperature of the comparative element 200 and determining an amount of SOF in exhaust gas using the temperature difference between the combustion element 100 and the comparative element 200.

That is, the present invention provides a sensor for measuring SOF using a catalyst having high combustion activity for SOF, that is, a sensor which can actively determine the amount of SOF in the PM of exhaust gas being discharged from a diesel engine in real time.

Specifically, the system for sensing the SOF of a diesel engine includes a combustion element 100 supported with a catalytic material having high combustion activity for SOF and a comparative element 200 supported with a stable material having no combustion activity for SOF. In this system, when the temperature of the combustion element 100 is increased by the exothermic reaction of SOF, the difference in temperature between the combustion element 100 and the comparative element 200 is measured by the detecting unit 300, thus determining the discharge amount of SOF.

Here, the combustion element 100 may uses platinum (Pt) as a catalytic material selectively causing a combustion reaction of SOF. This catalytic material is supported on a porous ceramic structure. Meanwhile, the comparative element 200, which is a means for measuring the combustion heat generated by the combustion reaction of the catalytic material of the combustion element 100 of SOF, may include TiO₂ as a main component.

Therefore, in this system, the detecting unit 300 measures the change and difference in temperature between the combustion element 100 including a catalytic material actively causing a combustion reaction of SOF in the exhaust gas of a diesel engine and the comparative element 200 including a stable element that does not cause the combustion reaction of SOF. This measurement is performed to determine the discharge amount of SOF. The measured temperature difference is converted into electrical signals to detect the discharge amount thereof in real time.

Meanwhile, the ceramic structure constituting the combustion element 100 and the comparative element 200 may be made of a composition including Al₂O₃ or a composition including SiO₂, and has a porous structure.

Of course, the ceramic structure may be made of different materials. However, Al₂O₃ or SiO₂ has a stable structure, does not have catalytic activity for SOF, and does not react with other materials. Therefore, it is preferred that the ceramic structure be made of a composition including Al₂O₃ or SiO₂. Further, the ceramic structure has a porous structure such that the catalytic material and stable material can be easily supported.

Meanwhile, the stable material supported on the comparative element 200 includes TiO₂ as a main component. In an exemplary embodiment of the present invention, the discharge amount of SOF is determined using the difference in temperature between the combustion element 100 including a catalytic material actively causing a combustion reaction of SOF in exhaust gas of a diesel engine and the comparative element 200 including a stable element not causing the combustion reaction of SOF, so that the comparative element 200 must use a material which does not cause a combustion reaction of SOF. Therefore, the comparative element 200 includes TiO₂, which does not cause a combustion reaction of SOF, as a stable material. As the amount of TiO₂ supported on the ceramic structure increases, the effect of TiO₂ as a stable material increases. Therefore, it is preferred that pure TiO₂ be used as the stable material.

Meanwhile, the catalytic material may use TiO₂ as a support, and may be supported with platinum (Pt) which causes a combustion reaction of SOF. The reason for this is that, when the support of the catalytic material supported on the combustion element 100 and the stable material supported on the comparative element 200 are made of TiO₂, the combustion heat generated by the combustion reaction of SOF can be quantified. Further, since platinum (Pt) used in the catalytic material has high selective catalytic activity for SOF, it can be preferably used as a component supported on the catalytic material of the combustion element 100.

For this reason, a temperature difference is created between the combustion element 100 and the comparative element 200, thus allowing the discharge amount of SOF to be determined. Further, the support of the catalytic material supported on the combustion element 100 and the stable material supported on the comparative element 200 are made of TiO₂, so that the temperature difference attributable to the combustion reaction of SOF can be accurately measured.

Meanwhile, the system for sensing SOF of a diesel engine according to an exemplary embodiment of the present invention further includes a heating unit for heating the combustion element 100. Generally, since the temperature of the exhaust gas of a diesel engine is not so high that SOF can be combusted, the heating unit 400 heats the combustion element 100 to a predetermined temperature to cause the combustion reaction of SOF in the exhaust gas with the catalytic material.

Accordingly, the combustion reaction of the catalytic material of the combustion element 100 of SOF is accelerated, so that the temperature of the combustion element 100 increases, thereby determining the discharge amount of SOF in the exhaust gas using the difference in temperature between the combustion element 100 and the comparative element 200.

In particular, it is preferred that the heating unit 400 heats the combustion element 100 and the comparative element 200 in the same manner. The reason for this is that, when the temperature difference between the combustion element 100 and the comparative element 200 is created by heating only the combustion element 100 or by other conditions other than the reaction of the combustion element of SOF, it is difficult to accurately determine the discharge amount of SOF. Therefore, it is preferred that the heating unit 400 heat the combustion element 100 and the comparative element 200 in the same manner in order to quantify the temperature of the combustion element 100 and the temperature of the comparative element 200.

Meanwhile, the detecting unit 300 converts the temperature difference between the combustion element 100 and the comparative element 200 into electrical signals to determine the discharge amount of SOF in the exhaust gas.

Specifically, the temperature difference between the combustion element 100 and the comparative element 200 can be determined by a contact combustion type sensor. When the combustion element 100 comes into contact with the SOF in the exhaust gas to cause a combustion reaction, the temperature of the combustion element 100 increases to increase the electric resistance thereof, and the changes in the electric resistance are converted into the electrical signals thereof, and then these electrical signals are compared with those of the comparative element 200, thereby determining the discharge amount of SOF. Accordingly, the discharge amount of SOF in the exhaust gas can be determined in real time, so that immediate action can be taken in response to the determination.

As described above, the system for sensing the SOF of a diesel engine according to an exemplary embodiment of the present invention can determine the discharge amount of SOF and detect the SOF in real time by applying a catalytic material, which has high combustion activity for the SOF in the PM of exhaust gas discharged from a diesel engine, to a combustion element.

Specifically, the discharge amount of SOF can be detected using the temperature difference between the combustion element including a catalytic material having high combustion activity for SOF and the comparative element having no combustion activity for SOF.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for sensing SOF (soluble organic fraction) of a diesel engine, comprising:
a combustion element including a porous ceramic structure supported with a catalyst material which causes a combustion reaction of the SOF in exhaust gas of the diesel engine;
a comparative element including a porous ceramic structure supported with a stable material which does not cause a combustion reaction of the SOF; and
a detecting unit detecting a temperature of the combustion element and a temperature of the comparative element and determining an amount of the SOF in the exhaust gas using a temperature difference between the combustion element and the comparative element.

2. The system for sensing the SOF of the diesel engine according to claim 1, wherein the ceramic structure of the combustion element or the comparative element is made of a composition including Al₂O₃.

3. The system for sensing the SOF of the diesel engine according to claim 1, wherein the ceramic structure of the comparative element or the comparative element is made of a composition including SiO₂.

4. The system for sensing the SOF of the diesel engine according to claim 1, wherein the stable material includes TiO₂ as a main component.

5. The system for sensing the SOF of the diesel engine according to claim 1, wherein the catalytic material uses TiO₂ as a support, and is supported with an element causing the combustion reaction of the SOF.

6. The system for sensing the SOF of the diesel engine according to claim 5, wherein the element is platinum (Pt).

7. The system for sensing the SOF of the diesel engine according to claim 1, further comprising:
a heating unit for heating the combustion element such that the catalytic material can cause the combustion reaction of the SOF in the exhaust gas.

8. The system for sensing the SOF of the diesel engine according to claim 7, wherein the heating unit heats the combustion element and the comparative element in the same manner.

9. The system for sensing the SOF of the diesel engine according to claim 1, wherein the detecting unit converts the temperature difference between the combustion element and the comparative element into an electric signal to determine the amount of the SOF in the exhaust gas.
